(19) United States
(12) Patent Application Publication
(10) Pub. No.: US 2005/0163699 A1
(43) Pub. Date: Jul. 28, 2005

(54) Fluorosulfate-based electrode active materials and method of making the same

(76) Inventors: Jeremy Barker, Oxfordshire (GB); M. Yazid Saidi, Henderson, NV (US); Jeffrey Swoyer, Henderson, NV (US)

Correspondence Address: VALENCE TECHNOLOGY, INC., 301 CONESTOGA WAY, HENDERSON, NV, 89015, US

(21) Appl. No.: 10/764,039

(22) Filed: Jan. 23, 2004

(51) Int. Cl. H01M 4/58

(52) U.S. Cl. 423/464; 429/231.9; 429/231.95; 429/231.5; 429/221; 429/223; 429/225; 429/224; 429/231.6

(57) ABSTRACT

The invention provides an electrochemical cell which includes a first electrode and a second electrode which is a counter electrode to said first electrode, and an electrolyte material interposed there between. The first electrode includes a fluorosulfate-based compound.

### FIELD OF THE INVENTION

This invention relates to improved fluorosulfate-based electrode active materials, methods for making such improved active materials, and electrochemical cells employing such improved active materials.

### BACKGROUND OF THE INVENTION

A battery consists of one or more electrochemical cells, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

Such batteries generally include an electrochemically active material having a crystal lattice structure or framework from which ions can be extracted and subsequently reinserted, and/or permit ions to be inserted or intercalated and subsequently extracted.

In general, positive electrode active materials should exhibit a high free energy of reaction with the cation (e.g. Li⁺, Na⁺, and the like), be able to release and insert a large quantity of cations, maintain its lattice structure upon insertion and extraction of cations, allow rapid diffusion of cations, afford good electrical conductivity, be not significantly soluble in the electrolyte system of the battery, and be readily and economically produced.

Unfortunately, many existing electrode materials are not economical to produce, afford insufficient voltage, have insufficient charge capacity, or lose their ability to be recharged over multiple cycles. Therefore, there is a current need for an electrode active material that exhibits greater charge capacity, is economical to produce, affords sufficient voltage, and retains capacity over multiple cycles.

### SUMMARY OF THE INVENTION

The present invention provides novel electrode materials represented by the nominal general formula:
AₐM_{b}(SO₄)_{c}Z_{d}
wherein:
(i) A is at least one alkali metal, and 0<a≦9;
(ii) M is at least one redox active element, and 1≦b≦4;
(iii) 1≦c≦3; and
(iv) Z is OH, a halogen, or mixtures thereof, and 0<d≦5;
wherein A, M, Z, a, b, c and d are selected so as to maintain electroneutrality of the material.

This invention also provides electrodes which utilize the electrode active material of this invention. Also provided are batteries that include a first electrode having an electrode active material of this invention; a second electrode having a compatible active material; and an electrolyte. In one embodiment, the novel electrode material of this invention is used as a positive electrode (cathode) active material, reversibly cycling alkali metal ions with a compatible negative electrode (anode) active material.

### DETAILED DESCRIPTION OF THE PREFERRED EMBODIMENTS

It has been found that the novel electrode materials, electrodes, and batteries of this invention afford benefits over such materials and devices among those known in the art. Such benefits include one or more of increased capacity, enhanced cycling capability, enhanced reversibility, enhanced ionic conductivity, enhanced electrical conductivity, and reduced costs. Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

The present invention provides electrode active materials for use in an electricity-producing electrochemical cell. Each electrochemical cell includes a positive electrode, a negative electrode, and an electrolyte in ion-transfer communication with both the positive and the negative electrode, for transferring ionic charge carriers there between. A “battery” refers to a device having one or more electricity-producing electrochemical cells. Two or more electrochemical cells may be combined, or “stacked,” so as to create a multi-cell battery.

The electrode active materials of this invention may be used in the negative electrode, the positive electrode, or both. Preferably, the active materials of this invention are used in the positive electrode. As used herein, the terms “negative electrode” and “positive electrode” refer to the electrodes at which oxidation and reduction occur, respectively, during battery discharge; during charging of the battery, the sites of oxidation and reduction are reversed.

### ELECTRODE ACTIVE MATERIALS OF THE PRESENT INVENTION

The present invention is directed to novel electrode active materials represented by the following nominal general formula (I):
AₐM_{b}(SO₄)_{c}Z_{d}. (I)

The term “nominal general formula” refers to the fact that the relative proportion of atomic species may vary slightly on the order of 2 percent to 5 percent, or more typically, 1 percent to 3 percent. The composition of A, M and Z of general formulas (I) through (III) herein, as well as the stoichiometric values of the elements of the active material, are selected so as to maintain electroneutrality of the electrode active material. The stoichiometric values of one or more elements of the composition may take on non-integer values.

For all embodiments described herein, unless otherwise specified, moiety A is selected from the group consisting of elements or alkali metals from Group I of the Periodic Table, and mixtures thereof. As referred to herein, “Group” refers to the Group numbers (i.e., columns) of the Periodic Table as defined in the current IUPAC Periodic Table. See, e.g., U.S. Pat. No. 6,136,472, Barker et al., issued Oct. 24, 2000, incorporated by reference herein. In one embodiment, A is selected from the group consisting of Li (Lithium), Na (Sodium), K (Potassium), and mixtures thereof. A may be a mixture of Li with Na, a mixture of Li with K, or a mixture of Li, Na and K. In another embodiment, A is Na, or a mixture of Na with K. In one preferred embodiment, A is Li.

As used herein, the recitation of a genus of elements, materials or other components, from which an individual component or mixture of components can be selected, is intended to include all possible sub-generic combinations of the listed components, and mixtures thereof. In addition, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

Removal of an amount of alkali metal (A) from the electrode active material is accompanied by a change in oxidation state of at least one of the “redox active” elements in the active material, as defined herein below. The amount of redox active material available for oxidation/reduction in the active material determines the amount of alkali metal (A) that may be removed. Such concepts are, in general application, well known in the art, e.g., as disclosed in U.S. Pat. No. 4,477,541, Fraioli, issued Oct. 16, 1984; and U.S. Pat. No. 6,136,472, Barker, et al., issued Oct. 24, 2000, both of which are incorporated by reference herein.

A sufficient quantity of alkali metal (A) should be present so as to allow all of the “redox active” elements of M (as defined herein below) to undergo oxidation/reduction. In one embodiment, 0<a≦9. In another embodiment, 0<a≦1. In yet another embodiment, 0<a≦3. In another embodiment, 3<a≦5. Unless otherwise specified, a variable described herein algebraically as equal to (“=”), less than or equal to (“≦”), or greater than or equal to (“≧”) a number is intended to subsume values or ranges of values about equal or functionally equivalent to said number.

In general, the amount (a) of alkali metal (A) in the active material varies during charge/discharge. Where the active materials of the present invention are synthesized for use in preparing an electrochemical cell in a discharged state, such active materials are characterized by a relatively high value of “a”, with a correspondingly low oxidation state of the redox active components of the active material. As the electrochemical cell is charged from its initial uncharged state, an amount (a′) of alkali metal (A) is removed from the active material as described above. The resulting structure, containing less alkali metal (i.e., a-a′) than in the as-prepared state, and at least one of the redox active components having a higher oxidation state than in the as-prepared state, essentially maintains the original value of c. The active materials of this invention include such materials in their nascent state (i.e., as manufactured prior to inclusion in an electrode) and materials formed during operation of the battery (i.e., by insertion or removal of alkali metal (A)).

In all embodiments described herein, M includes at least one redox active element. As used herein, the term “redox active element” includes those elements characterized as being capable of undergoing oxidation/reduction to another oxidation state when the electrochemical cell is operating under normal operating conditions. As used herein, the term “normal operating conditions” refers to the intended voltage at which the cell is charged, which, in turn, depends on the materials used to construct the cell.

Redox active elements useful herein with respect to M include, without limitation, elements from Groups 4 through 11 of the Periodic Table, as well as select non-transition metals, including, without limitation, Ti (Titanium), V (Vanadium), Cr (Chromium), Mn (Manganese), Fe (Iron), Co (Cobalt), Ni (Nickel), Cu (Copper), Nb (Niobium), Mo (Molybdenum), Ru (Ruthenium), Rh (Rhodium), Pd (Palladium), Os (Osmium), Ir (Iridium), Pt (Platinum), Au (Gold), Si (Silicon), Sn (Tin), Pb (Lead), and mixtures thereof. As referred to herein, “include,” and its variants, is intended to be non-limiting, such that recitation of items in a list is not to the exclusion of other like items that may also be useful in the materials, compositions, devices, and methods of this invention.

In one embodiment, moiety M is a redox active element. In one subembodiment, M is a redox active element selected from the group consisting of Ti²⁺, V²⁺, C²⁺, Mn²⁺, Fe²⁺, Co²⁺, Ni²⁺, Cu²⁺, Mo²⁺, Si²⁺, Sn²⁺, and Pb²⁺. In another subembodiment, M is a redox active element selected from the group consisting of Ti³⁺, V³⁺, Cr³⁺, Mn³⁺, Fe³⁺, Co³⁺, Ni³⁺, Mo³⁺, and Nb³⁺.

In another embodiment, moiety M is a mixture of redox active elements or a mixture of at least one redox active element and at least one non-redox active element. As referred to herein, “non-redox active elements” include elements that are capable of forming stable active materials, and do not undergo oxidation/reduction when the electrode active material is operating under normal operating conditions.

Among the non-redox active elements useful herein include, without limitation, those selected from Group 2 elements, particularly Be (Beryllium), Mg (Magnesium), Ca (Calcium), Sr (Strontium), Ba (Barium); Group 3 elements, particularly Sc (Scandium), Y (Yttrium), and the lanthanides, particularly La (Lanthanum), Ce (Cerium), Pr (Praseodymium), Nd (Neodymium), Sm (Samarium); Group 12 elements, particularly Zn (Zinc) and Cd (Cadmium); Group 13 elements, particularly B (Boron), Al (Aluminum), Ga (Gallium), In (Indium), Tl (Thallium); Group 14 elements, particularly C (Carbon) and Ge (Germanium), Group 15 elements, particularly As (Arsenic), Sb (Antimony), and Bi (Bismuth); Group 16 elements, particularly Te (Tellurium); and mixtures thereof.

In one embodiment, M=MIₙMIIₒ, wherein 0<o+n≦4 and each of o and n is greater than zero (0<o,n), wherein MI and MII are each independently selected from the group consisting of redox active elements and non-redox active elements, wherein at least one of MI and MII is redox active.

MI may be partially substituted with MII by isocharge or aliovalent substitution, in equal or unequal stoichiometric amounts. “Isocharge substitution” refers to a substitution of one element on a given crystallographic site with an element having the same oxidation state (e.g. substitution of Ca²⁺ with Mg²⁺). “Aliovalent substitution” refers to a substitution of one element on a given crystallographic site with an element of a different oxidation state (e.g. substitution of Li⁺ with Mg²⁺).

For all embodiments described herein where MI is partially substituted by MII by isocharge substitution, MI may be substituted by an equal stoichiometric amount of MII, whereby M=MIₙ₋ₒMIIₒ. Where MI is partially substituted by MII by isocharge substitution and the stoichiometric amount of MI is not equal to the amount of MII, whereby M=MIₙ₋ₒMIIₚ and o≠p, then the stoichiometric amount of one or more of the other components (e.g. A and Z) in the active material must be adjusted in order to maintain electroneutrality.

For all embodiments described herein where MI is partially substituted by MII by aliovalent substitution and an equal amount of MI is substituted by an equal amount of MII, whereby M=MIₙ₋ₒMIIₒ, then the stoichiometric amount of one or more of the other components (e.g. A and Z) in the active material must be adjusted in order to maintain electroneutrality. However, MI may be partially substituted by MII by aliovalent substitution by substituting an “oxidatively” equivalent amount of MII for MI, whereby

$$M = M {I}_{n - \frac{o}{{V}^{MI}}} M I {I}_{\frac{o}{{V}^{MII}}} ,$$

wherein V^{MI} is the oxidation state of MI, and V^{MII} is the oxidation state of MII.

In one subembodiment, MI is selected from the group consisting of Ti, V, Cr, Mn, Fe, Co, Ni, Cu, Mo, Si, Pb, Mo, Nb, and mixtures thereof, and MII is selected from the group consisting of Be, Mg, Ca, Sr, Ba, Sc, Y, Zn, Cd, B, Al, Ga, In, C, Ge, and mixtures thereof. In this subembodiment, MI may be substituted by MII by isocharge substitution or aliovalent substitution.

In another subembodiment, MI is partially substituted by MII by isocharge substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is selected from the group specified immediately above, and MII is selected from the group consisting of Be²⁺, Mg²⁺, Ca²⁺, Sr²⁺, Ba²⁺, and mixtures thereof. In another aspect of this subembodiment, MI is selected from the group specified above, and MII is selected from the group consisting of Zn²⁺, Cd²⁺, and mixtures thereof. In yet another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Sc³⁺, Y³⁺, B³⁺, Al³⁺, Ga³⁺, In³⁺, and mixtures thereof.

In another embodiment, MI is partially substituted by MII by aliovalent substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Sc³⁺, Y³⁺, B³⁺, Al³⁺, Ga³⁺, In³⁺, and mixtures thereof. In another aspect of this subembodiment, MI is a 2+ oxidation state redox active element selected from the group specified immediately above, and MII is selected from the group consisting of alkali metals, Cu¹⁺, Ag¹⁺ and mixtures thereof. In another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another of this subembodiment, MI is a 3+ oxidation state redox active element selected from the group specified immediately above, and MI[ is selected from the group consisting of alkali metals, Cu¹⁺, Ag¹⁺ and mixtures thereof.

In another embodiment, M=M1_{q}M2ᵣM3ₛ, wherein:
(a) M1 is a redox active element with a 2+ oxidation state;
(b) M2 is selected from the group consisting of redox and non-redox active elements with a 1+ oxidation state;
(c) M3 is selected from the group consisting of redox and non-redox active elements with a 3+ oxidation state; and
(d) at least one of p, q and r is greater than 0, and at least one of M1, M2, and M3 is redox active. Preferably, each of p, q and r is greater than 0 (0<p,q,r).

In one subembodiment, M1 is substituted by an equal amount of M2 and/or M3, whereby q=q−(r+s). In this subembodiment, then the stoichiometric amount of one or more of the other components (e.g. A and Z) in the active material must be adjusted in order to maintain electroneutrality.

In another subembodiment, M1 is substituted by an “oxidatively” equivalent amount of M2 and/or M3, whereby

$$M = M {1}_{q - \frac{r}{{V}^{M 1}} - \frac{s}{{V}^{M 1}}} M {2}_{\frac{r}{{V}^{M 2}}} M {3}_{\frac{s}{{V}^{M 3}}} ,$$

wherein V^{M1} is the oxidation state of M1, V^{M2} is the oxidation state of M2, and V^{M'}is the oxidation state of M3.

In one subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of alkali metals, Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Be²⁺, Mg²⁺, Ca²⁺, Sr₂₊, Ba²⁺, Zn²⁺, Cd²⁺, Ge²⁺, and mixtures thereof; M2 is selected from the group consisting of alkali metals, Cu¹⁺, Ag¹⁺, and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of alkali metals, Cu¹⁺, Ag¹⁺, and mixtures thereof; and M3 is selected from the group consisting of Sc³⁺, Y³⁺, B³⁺, Al³⁺, Ga³⁺, In³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In one embodiment of the present invention, c=1. In another embodiment of the present invention, c=3.

In all embodiments described herein, unless otherwise specified, moiety Z is selected from the group consisting of OH (Hydroxyl), a halogen, and mixtures thereof. In one embodiment, Z is selected from the group consisting of OH (Hydroxyl), F (Fluorine), Cl (Chlorine), Br (Bromine), and mixtures thereof. In another embodiment, Z is OH. In another embodiment, Z is F, or a mixture of F with OH, Cl, or Br.

In one particular embodiment, the electrode active material is represented by the nominal general formula (II):
AₐM_{b}SO₄Z_{d}, (II)
wherein:
(a) the moieties A, M and Z are as defined herein above;
(b) 0<a≦2;0<m≦2,and0<d≦1;and
(c) the components of the moieties A, M and Z, as well as the values for a, b and d, are selected so as to maintain electroneutrality of the compound.

In one particular subembodiment, A of general formula (II) is Li, and M includes a 2+ oxidation state redox active element selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, and Pb²⁺ (preferably Fe²⁺).

In another particular embodiment, the electrode active material is represented by the nominal general formula (III):
AₐM_{b}(SO₄)₃Z_{d}, (III)
wherein:
(a) the moieties A, M and Z are as defined herein above;
(b) 0<a≦5; 1<m≦3,and0<d≦4;and
(c) the components of the moieties A, M and Z, as well as the values for a, b and d, are selected so as to maintain electroneutrality of the compound.

In one particular subembodiment, A of general formula (III) is Li, and M includes a 3+ oxidation state redox active element selected from the group consisting of Ti³⁺, V³⁺, Cr³⁺, Mn³⁺, Fe³⁺, Co³⁺, Ni³⁺, Mo³⁺, Nb³⁺, and mixtures thereof (preferably V³⁺).

Methods of Manufacture:

The particular starting materials employed will depend on the particular active material to be synthesized, reaction method employed, and desired by-products. The compounds of the present invention are synthesized by reacting at least one A-containing compound, one or more M-containing compounds, at least one SO₄-containing compound, and one or more Z-containing compounds, at a temperature and for a time sufficient to form the desired reaction product. As used herein, the term “containing” includes compounds which contain the particular component, or react to form the particular component so specified.

Sources of alkali metal include any of a number of alkali metal-containing salts or ionic compounds. Lithium, sodium, and potassium compounds are preferred, with lithium being particularly preferred. A wide range of such materials is well known in the field of inorganic chemistry. Examples include the alkali metal-containing fluorides, chlorides, bromides, iodides, nitrates, nitrites, sulfates, hydrogen sulfates, sulfites, bisulfites, carbonates, bicarbonates, borates, phosphates, silicates, antimonates, arsenates, germanates, oxides, acetates, oxalates, and the like. Hydrates of the above compounds may also be used, as well as mixtures thereof. The mixtures may contain more than one alkali metal so that a mixed alkali metal active material will be produced in the reaction.

Sources of M include, without limitation, M-containing fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germanates, oxides, hydroxides, acetates, and oxalates of the same. Hydrates may also be used. M in the starting material may have any oxidation state, depending on the oxidation state required in the desired product and the oxidizing or reducing conditions contemplated, if any.

Sulfate compounds that can be used to synthesize the active material include alkali metal and transition metal sulfates and bisulfates as well as mixed metal sulfates such as (NH₄)₂Fe(SO₄)₂, NH₄Fe(SO₄)₂, and the like.

As noted above, the active materials of the present invention contain a mixture of A, M, SO₄, and Z. A starting material may provide more than one of these components, as is evident in the list above. In various embodiments of the invention, starting materials are provided that combine, for example, M and SO₄, thus requiring only the alkali metal and Z to be added. In one embodiment, a starting material is provided that contains A, M and SO₄. As a general rule, there is sufficient flexibility to allow selection of starting materials containing any of the components of A, M, SO₄, and Z, depending on availability. Combinations of starting materials providing each of the components may also be used.

In general, any counterion may be combined with A, M, SO₄, and Z. It is preferred, however, to select starting materials with counterions that give rise to the formation of volatile by-products during the reaction. Thus, it is desirable to choose ammonium salts, carbonates, bicarbonates, oxides, hydroxides, and the like, where possible. Starting materials with these counterions tend to form volatile by-products such as water, ammonia, and carbon dioxide, which can be readily removed from the reaction mixture. Nitrogen-containing anions such as nitrate and nitrite also tend to give volatile NOₓ by-products.

Additionally, in some cases the performance of the active material may be dependent upon the amount of each reactant present in the reaction mixture. This is because the presence of certain unreacted starting materials in the active material may have a detrimental effect on the electrochemical performance of the active material. One with ordinary skill in the art would readily be able to optimize the electrochemical performance of the active material synthesized by choosing one of the reactants to be the limiting reagent, taking into account any impurities present in the reaction mixture, and comparing the electrochemical performance of the resulting active material to similar active materials wherein alternate reactants are chosen to be the limiting reagent.

One method for preparing the active materials of the present invention is via the hydrothermal treatment of the requisite starting materials. In a hydrothermal reaction, the starting materials are mixed with a small amount of a liquid (e.g. water), and heated in a pressurized vessel or bomb at a temperature that is relatively lower as compared to the temperature necessary to produce the active material in an oven at ambient pressure. Preferably, the reaction is carried out at a temperature of about 150° C. to about 450° C., under pressure, for a period of about 4 to about 48 hours, or until a reaction product forms.

A “sol-gel” preparation method may also be employed. Using this method, solute precursors with the required components are mixed in solution and then transformed into a solid via precipitation or gelation. The resulting wet powder or gel is dried at about 100° C. to about 400° C. for about 1 hour to about 4 hours, optionally, heated up to about 450° C. to about 700° C. for an additional 1 hour to about 4 hours.

Another method for synthesizing the active materials of the present invention is via a thermite reaction, wherein M is reduced by a granular or powdered metal present in the reaction mixture.

The active materials of the present invention can also be synthesized via a solid state reaction, with or without simultaneous oxidation or reduction of M, by heating the requisite starting materials at an elevated temperature for a given period of time, until the desired reaction product forms.

The starting materials are provided in powder or particulate form, and are mixed together by any of a variety of procedures, such as by ball milling, blending in a mortar and pestle, and the like. Typically, the starting materials are ball milled for 12-18 hours, rolling at a rate of 20 rpm. Thereafter the mixture of powdered starting materials may be compressed into a pellet and/or held together with a binder material (which may also serve as a source of reducing agent) to form a closely cohering reaction mixture. The reaction mixture is heated in an oven, generally at a temperature of about 300° C. or greater, until a reaction product forms.

The reaction may be carried out under reducing or oxidizing conditions. Reducing conditions may be provided by performing the reaction in a “reducing atmosphere” such as hydrogen, ammonia, carbon monoxide, methane, or mixtures thereof, or other suitable reducing gas. Alternatively or in addition thereto, the reduction may be carried out in situ by including in the reaction mixture a reducent that will participate in the reaction to reduce M to a lower oxidation state, and produce by-products that will not interfere with the active material when later used in an electrode or an electrochemical cell.

In one embodiment, the reducent is elemental carbon, wherein reduction is accomplished via simultaneous oxidation of carbon to carbon monoxide and/or carbon dioxide. An excess of carbon, remaining after the reaction, is intimately mixed with the product active material and functions as a conductive constituent in the ultimate electrode formulation. Accordingly, excess carbon, on the order of 100% or greater, may be used. The presence of carbon particles in the starting materials also provides nucleation sites for the production of the product crystals.

The source of reducing carbon may also be provided by an organic material that forms a carbon-rich decomposition product, referred to herein as a “carbonaceous material,” and other by-products upon heating under the conditions of the reaction. At least a portion of the organic precursor, carbonaceous material and/or by-products formed by decomposition functions as a reducent during the synthesis reaction, before, during and/or after the organic precursor undergoes thermal decomposition. Such precursors include any liquid or solid organic material (e.g. sugars and other carbohydrates, including derivatives and polymers thereof).

Although the reaction may be carried out in the presence of oxygen, the reaction is preferably conducted under an essentially non-oxidizing atmosphere so as not to interfere with the reduction reactions taking place. An essentially non-oxidizing atmosphere can be achieved through the use of a vacuum, or through the use of inert gases such as argon, nitrogen, and the like.

Preferably, the particulate starting materials are heated to a temperature below the melting point of the starting materials. The temperature should be about 300° C. or greater, and desirably about 450° C. or greater. CO and/or CO₂ gas evolves during the reaction. Higher temperatures favor CO formation. Some of the reactions are more desirably conducted at temperatures greater than about 600° C.; most desirably greater than about 650° C. Suitable ranges for many reactions are from about 700° C. to about 950° C.

At about 700° C. both the C→CO and the C→CO₂ reactions are occurring. At closer to about 600° C. the C→CO₂ reaction is the dominant reaction. At closer to about 800° C. the C→CO reaction is dominant. Since the reducing effect of the C→CO₂ reaction is greater, the result is that less carbon is needed per atomic unit of M to be reduced.

The starting materials may be heated at ramp rates from a fraction of a degree up to about 10° C. per minute. In some cases, for example where continuously heated rotary furnaces are employed, the ramp rate may be significantly higher. Once the desired reaction temperature is attained, the reactants (starting materials) are held at the reaction temperature for a time sufficient for the reaction to occur. Typically the reaction is carried out for several hours at the final reaction temperature.

After the reaction is complete, the products are preferably cooled from the elevated temperature to ambient (room) temperature (i.e., about 10° C. to about 40° C.). It is also possible to quench the products to achieve a higher cooling rate, for example on the order of about 100° C./minute. The thermodynamic considerations such as ease of reduction of the selected starting materials, the reaction kinetics, and the melting point of the reactants will cause adjustment in the general procedure, such as the amount of reducing agent, the temperature of the reaction, and the dwell time.

Electrochemical Cells:

To form an electrode, the active material of the present invention may be combined with a polymeric binder (e.g. polyvinylidene difluoride (PVdF) and hexafluoropropylene (HFP)) in order to form a cohesive mixture. The mixture this then placed in electrical communication with a current collector which, in turn, provides electrical communication between the electrode and an external load. The mixture may be formed or laminated onto the current collector, or an electrode film may be formed from the mixture wherein the current collector is embedded in the film. Suitable current collectors include reticulated or foiled metals (e.g. aluminum, copper and the like). An electrically conductive diluent or agent (e.g. a carbon such as carbon black and the like) may be added to the mixture so as to increase the electrical conductivity of the electrode. In one embodiment, the electrode material is pressed onto or about the current collector, thus eliminating the need for the polymeric binder. In one embodiment, the electrode contains 5 to 30% by weight electrically conductive agent, 3 to 20% by weight binder, and the remainder being the electrode active material.

To form an electrochemical cell, a solid electrolyte or an electrolyte-permeable separator is interposed between the electrode and a counter-electrode. In one embodiment, the electrolyte contains a solvent selected from the group consisting of the electrolyte comprises a lithium salt and a solvent selected from the group consisting of dimethyl carbonate (DMC), diethylcarbonate (DEC), dipropylcarbonate (DPC), ethylmethylcarbonate (EMC), ethylene carbonate (EC), propylene carbonate (PC), butylene carbonate, lactones, esters, glymes, sulfoxides, sulfolanes, and mixtures thereof; and 5 to 65% by weight of an alkali metal salt. Preferred solvent combinations include EC/DMC, EC/DEC, EC/DPC and EC/EMC. In one embodiment, the counter-electrode contains an intercalation active material selected from the group consisting of a transition metal oxide, a metal chalcogenide, carbon (e.g. graphite), and mixtures thereof. Counter electrodes, electrolyte compositions, and methods for making the same, among those useful herein, are described in U.S. Pat. No. 5,700,298, Shi et al., issued Dec. 23, 1997; U.S. Pat. No. 5,830,602, Barker et al., issued Nov. 3, 1998; U.S. Pat. No. 5,418,091, Gozdz et al., issued May 23, 1995; U.S. Pat. No. 5,508,130, Golovin, issued Apr. 16, 1996; U.S. Pat. No. 5,541,020, Golovin et al., issued Jul. 30, 1996; U.S. Pat. No. 5,620,810, Golovin et al., issued Apr. 15, 1997; U.S. Pat. No. 5,643,695, Barker et al., issued Jul. 1, 1997; U.S. Pat. No. 5,712,059, Barker et al., issued Jan. 27, 1997; U.S. Pat. No. 5,851,504, Barker et al., issued Dec. 22, 1998; U.S. Pat. No. 6,020,087, Gao, issued Feb. 1, 2001; and U.S. Pat. No. 6,103,419, Saidi et al., issued Aug. 15, 2000; all of which are incorporated by reference herein.

Electrochemical cells composed of electrodes (including polymer-type stacked cells and cylindrical-type cells), electrolytes and other materials, among those useful herein, are described in the following documents, all of which are incorporated by reference herein: U.S. Pat. No. 4,668,595, Yoshino et al., issued May 26, 1987; U.S. Pat. 4,792,504, Schwab et al., issued Dec. 20, 1988; U.S. Pat. No. 4,830,939, Lee et al., issued May 16, 1989; U.S. Pat. No. 4,935,317, Fauteaux et al., issued Jun. 19, 1980; U.S. Pat. No. 4,990,413, Lee et al., issued Feb. 5, 1991; U.S. Pat. No. 5,037,712, Shackle et al., issued Aug. 6, 1991; U.S. Pat. No. 5,262,253, Golovin, issued Nov. 16, 1993; U.S. Pat. No. 5,300,373, Shackle, issued Apr. 5, 1994; U.S. Pat. No. 5,399,447, Chaloner-Gill, et al., issued Mar. 21, 1995; U.S. Pat. No. 5,411,820, Chaloner-Gill, issued May 2, 1995; U.S. Pat. No. 5,435,054, Tonder et al., issued Jul. 25, 1995; U.S. Pat. No. 5,463,179, Chaloner-Gill et al., issued Oct. 31, 1995; U.S. Pat. No. 5,482,795, Chaloner-Gill., issued Jan. 9, 1996; U.S. Pat. No. 5,660,948, Barker, issued Sep. 16, 1995; U.S. Pat. No. 5,869,208, Miyasaka, issued Feb. 9, 1999; U.S. Pat. No. 5,882,821, Miyasaka, issued Mar. 16, 1999; U.S. Pat. No. 5,616,436, Sonobe. et al., issued Apr. 1, 1997; and U.S. Pat. No. 6,306,215, Larkin, issued Oct. 23, 2001.

The following non-limiting examples illustrate the compositions and methods of the present invention.

### EXAMPLE 1

An electrode active material having the formula LiNiSO₄F is made as follows. The following starting materials are provided, and the reaction proceeds as follows.
NiSO₄+LiF→LiNiSO₄F

The reactants are pre-mixed according to the following proportions:

| | |
|---|---|
| 0.02 moles NiSO₄ (mol. wt. = 154.75 g/mol) | 2.57 g |
| 0.02 moles LiF (25.94 g/mol) | 0.43 g |

The above starting materials are combined and ball milled to mix the particles. Thereafter, the particle mixture is pelletized. The pelletized mixture is heated, preferably in a flowing inert atmosphere (e.g. argon), until a reaction product forms. The sample is removed from the oven and cooled. A first sample synthesized by this method (12 hour dwell time ramped at 2° C. per minute to 600° C.) yielded a soft yellow/green/white pellet with inconsistent uniformity. A second sample synthesized by this method (30 minute dwell time at 600° C. in air) yielded a hard yellow pellet with good uniformity.

### EXAMPLE 2

An electrode active material having the formula LiFeSO₄F is made as follows. The following starting materials are provided, and the reaction proceeds as follows.
FeSO₄+LiF→LiFeSO₄F

The reactants are pre-mixed according to the following proportions:

| | |
|---|---|
| 0.01 moles FeSO₄ (dry) (mol. wt. = 151.91 g/mol) | 1.71 g |
| 0.01 moles LiF (25.94 g/mol) | 0.29 g |

The above-noted mixture is subjected to the reaction conditions specified in Example 1 to form the LiFeSO₄F active material. A first sample synthesized by this method (12 hour dwell time ramped at 2° C. per minute to 600° C.) yielded a semi-hard red/grey pellet with inconsistent uniformity. A second sample synthesized by this method (15 minute dwell time at 500° C. in air) yielded a hard brown/black/red reaction product with good uniformity. A third sample synthesized by this method (15 minute dwell time at 450° C. in air) yielded a hard red/grey reaction product with satisfactory uniformity.

### EXAMPLE 3

An electrode active material having the formula LiCoSO₄F is made as follows. The following starting materials are provided, and the reaction proceeds as follows.
CoSO₄+LiF→LiCoSO₄F

The reactants are pre-mixed according to the following proportions:

| | |
|---|---|
| 0.02 moles CoSO₄ (mol. wt. = 154.99 g/mol) | 2.57 g |
| 0.02 moles LiF (25.94 g/mol) | 0.43 g |

The above-noted mixture is subjected to the reaction conditions specified in Example 1 to form the LiCoSO₄F active material. A first sample prepared by this method (15 minute dwell time at 650° C. in air) melted. When the reaction was repeated at 500° C. in air, the reaction yielded a hard purple pellet with satisfactory uniformity.

### EXAMPLE 4

An electrode active material having the formula LiMnSO₄F is made as follows. The following starting materials are provided, and the reaction proceeds as follows.
MnSO₄+LiF→LiMnSO₄F

The reactants are pre-mixed according to the following proportions:

| | |
|---|---|
| 0.02 moles MnSO₄ (mol. wt. = 151.00 g/mol) | 2.56 g |
| 0.02 moles LiF (25.94 g/mol) | 0.44 g |

The above-noted mixture is subjected to the reaction conditions specified in Example 1 to form the LiMnSO₄F active material. A first sample synthesized by this method (5 minute dwell time at 650° C. in air) melted during heating. A second sample synthesized by this method (15 minute dwell time at 500° C. in air) yielded a hard light-tan pellet with satisfactory uniformity. A third sample synthesized by this method (1 hour dwell time at 450° C. in air) yielded a semi-hard light-tan/peach pellet with good uniformity.

### EXAMPLE 5

An electrode active material having the formula LiMn_{0.9}Mg_{0.1}SO₄F is made as follows. The following starting materials are provided, and the reaction proceeds as follows.
0.9 MnSO₄+0.1 MgSO₄+LiF→LiMn_{0.9}Mg_{0.1}SO₄F

The reactants are pre-mixed according to the following proportions:

| | |
|---|---|
| 0.015 moles MnSO₄ (mol. wt. = 151.00 g/mol) | 2.31 g |
| 0.002 moles MgSO₄ (120.36 g/mol) | 0.20 g |
| 0.020 moles LiF (25.94 g/mol) | 0.44 g |

The above-noted mixture is subjected to the reaction conditions specified in Example 1 to form the LiMn_{0.9}Mg_{0.1}SO₄F active material. A sample synthesized by this method (15 minute dwell time at 500° C. in controlled air) yielded a hard light-tan pellet with satisfactory uniformity.

### EXAMPLE 6

An electrode active material having the formula LiFe_{0.9}Zn_{0.1}SO₄F is made as follows. The following starting materials are provided, and the reaction proceeds as follows.
0.9 FeSO₄+0.1 ZnSO₄+LiF→LiFe_{0.9}Zn_{0.1}SO₄F

The reactants are pre-mixed according to the following proportions:

| | |
|---|---|
| 0.015 moles FeSO₄ (dry) (mol. wt. = 151.91 g/mol) | 2.32 g |
| 0.002 moles ZnSO₄ (161.44 g/mol) | 0.27 g |
| 0.020 moles LiF (25.94 g/mol) | 0.44 g |

The above-noted mixture is subjected to the reaction conditions specified in Example 1 to form the LiMn_{0.9}Zn_{0.1}SO₄F active material. A sample synthesized by this method (15 minute dwell time at 500° C. in controlled air) yielded a pellet with satisfactory uniformity.

### EXAMPLE 7

An electrode active material having the formula LiFe_{0.5}Co_{0.5}SO₄F is made as follows. The following starting materials are provided, and the reaction proceeds as follows.
0.5 FeSO₄+0.5 CoSO₄+LiF→LiFe_{0.5}Co_{0.5}SO₄F

The reactants are pre-mixed according to the following proportions:

| | |
|---|---|
| 0.008 moles FeSO₄ (dry) (mol. wt. = 151.91 g/mol) | 1.29 g |
| 0.008 moles CoSO₄ (154.99 g/mol) | 1.32 g |
| 0.016 moles LiF (25.94 g/mol) | 0.41 g |

The above-noted mixture is subjected to the reaction conditions specified in Example 1 to form the LiMn_{0.9}Zn_{0.1}SO₄F active material. A sample synthesized by this method (15 minute dwell time at 500° C. in controlled air) yielded a pellet with satisfactory uniformity.

### EXAMPLE 8

An electrode active material having the formula Li₃Fe₂(SO₄)₃F is made as follows. The following starting materials are provided, and the reaction proceeds as follows.
Li₂SO₄+2 FeSO₄+LiF→Li₃Fe₂(SO₄)₃F

The reactants are pre-mixed according to the following proportions:

| | |
|---|---|
| 0.02 moles FeSO₄ (dry) (mol. wt. = 151.91 g/mol) | 3.04 g |
| 0.01 moles Li₂SO₄ (109.94 g/mol) | 1.10 g |
| 0.01 moles LiF (25.94 g/mol) | 0.26 g |

The above-noted mixture is subjected to the reaction conditions specified in Example 1 to form the Li₃Fe₂(SO₄)₃F active material. A sample synthesized by this method (15 minute dwell time at 500° C. in controlled air) yielded a pellet with satisfactory uniformity.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

1. A compound represented by the nominal general formula:
AₐM_{b}(SO₄)_{c}Z_{d},
wherein:
(i) A is at least one alkali metal, and 0<a≦9;
(ii) M includes at least one redox active element, and 1≦b≦4;
(iii) 1≦c≦3; and
(v) Z is OH, a halogen, or mixtures thereof, and 0<d≦5;
wherein A, M, Z, a, b, c and d are selected so as to maintain electroneutrality of the compound.

2. The compound of claim 1, wherein A is selected from the group consisting of Li, K, Na, and mixtures thereof.

3. The compound of claim 1, wherein A is Li.

4. The compound of claim 1, wherein M is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, and Pb²⁺.

5. The compound of claim 1, wherein M is selected from the group consisting of Ti³⁺, V³⁺, Cr³⁺, Mn³⁺, Fe³⁺, Co³⁺, Ni³⁺, Mo³⁺, and Nb³⁺.

6. The compound of claim 1, wherein M=MIₙMIIₒ, 0<o+n≦4 and 0<o,n, wherein MI and MII are each independently selected from the group consisting of redox active elements and non-redox active elements, wherein at least one of MI and MII is redox active.

7. The compound of claim 6, wherein MI and MII are both redox active.

8. The compound of claim 6, wherein MI is substituted by MII by isocharge substitution.

9. The compound of claim 8, wherein M=MIₙ₋ₚMIIₒ, and o=p.

10. The compound of claim 8, wherein M=MIₙ₋ₚMIIₒ, and o≠p.

11. The compound of claim 8, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof.

12. The compound of claim 8, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, and mixtures thereof.

13. The compound of claim 8, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Zn²⁺, Cd²⁺, and mixtures thereof.

14. The compound of claim 8, wherein MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Sc³⁺, Y³⁺, B³⁺, Al³⁺, Ga³⁺, In³⁺, and mixtures thereof.

15. The compound of claim 8, wherein MI is substituted by MII by aliovalent substitution.

16. The compound of claim 15, wherein M=MIₙ₋ₒMIIₒ.

17. The compound of claim 15, wherein
$$M = M {I}_{n - \frac{o}{{V}^{MI}}} M I {I}_{\frac{o}{{V}^{MII}}} ,$$
wherein V^{MI} is the oxidation state of MI, and V^{MII} is the oxidation state of MII.

18. The compound of claim 17, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Sc³⁺, Y³⁺, B³⁺, Al³⁺, Ga³⁺, In³⁺, and mixtures thereof.

19. The compound of claim 17, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of alkali metals, Cu¹⁺, Ag¹⁺, and mixtures thereof.

20. The compound of claim 17, wherein MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof.

21. The compound of claim 17, wherein MI is selected from the group consisting of Ti³⁺, V³⁺, Cr³⁺, Mn³⁺, Fe³⁺, Co³⁺, Ni³⁺, Mo³⁺, Nb³⁺, and mixtures thereof MII is selected from the group consisting of alkali metals, Cu¹⁺, Ag¹⁺, and mixtures thereof.

22. The compound of claim 1, wherein M=M1_{q}M2ᵣM3ₛ, wherein:
(a) M1 is a redox active element with a 2+ oxidation state;
(b) M2 is selected from the group consisting of redox and non-redox active elements with a 1+ oxidation state;
(c) M3 is selected from the group consisting of redox and non-redox active elements with a 3+ oxidation state; and
(d) at least one of q, r and s is greater than 0, and at least one of M1, M2, and M3 is redox active.

23. The compound of claim 22, wherein q=q−(r+s).

24. The compound of claim 22, wherein
$$M = M {1}_{q - \frac{r}{{V}^{M 1}} - \frac{s}{{V}^{M 1}}} M {2}_{\frac{r}{{V}^{M 2}}} M {3}_{\frac{s}{{V}^{M 3}}} ,$$
wherein V^{M1} is the oxidation state of M1, V^{M2} is the oxidation state of M2, and V^{M3} is the oxidation state of M3.

25. The compound of claim 24, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of alkali metals, Cu¹⁺, Ag¹⁺, and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof.

26. The compound of claim 24, wherein M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Li¹⁺, K¹⁺, Na¹⁺, Ru¹⁺, Cs¹⁺, and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof.

27. The compound of claim 24, wherein M1 is selected from the group consisting of Be²⁺, Mg²⁺, Ca²⁺, Sr²⁺, Ba²⁺, Zn²⁺, Cd²⁺, Ge²⁺, and mixtures thereof; M2 is selected from the group consisting of alkali metals, Cu¹⁺, Ag¹⁺, and mixtures thereof; and M3 is selected from the group consisting of Ti³⁺, V³⁺, Cr³⁺, Mn³⁺, Fe³⁺, Co³⁺, NI³⁺, Mo³⁺, Nb³⁺, and mixtures thereof.

28. The compound of claim 24, wherein M1 is selected from the group consisting of Be²⁺, Mg²⁺, Ca²⁺, Sr²⁺, Ba²⁺, Zn²⁺, Cd²⁺, Ge²⁺, and mixtures thereof; M2 is selected from the group consisting of Li¹⁺, K¹⁺, Na¹⁺, Ru¹⁺, Cs¹⁺, and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof.

29. The compound of claim 24, wherein M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of alkali metals, Cu¹⁺, Ag¹⁺ and mixtures thereof; and M3 is selected from the group consisting of Sc³⁺, Y³⁺, B³⁺, Al³⁺, Ga³⁺, In³⁺, and mixtures thereof.

30. The compound of claim 24, wherein M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Li¹⁺, K¹⁺, Na¹⁺, Ru¹⁺, Cs¹⁺, and mixtures thereof; and M3 is selected from the group consisting of Sc³⁺, Y³⁺, B³⁺, Al³⁺, Ga³⁺, In³⁺, and mixtures thereof.

31. The compound of claim 22, wherein 0<q, r, s.

32. The compound of claim 1, wherein c=1.

33. The compound of claim 1, wherein c=3.

34. The compound of claim 1, wherein Z is OH.

35. A battery, comprising:
a first electrode comprising a compound represented by the nominal general formula:
AₐM_{b}(SO₄)_{c}Z_{d},
wherein:
(i) A is at least one alkali metal, and 0<a≦9;
(ii) M includes at least one redox active element, and 1≦b≦4;
(iii) 1≦c≦3; and
(v) Z is OH, a halogen, or mixtures thereof, and 0<d≦5; wherein A, M, Z, a, b, c and d are selected so as to maintain electroneutrality of the compound;
the battery further comprising a second counter-electrode comprising an intercalation active material; and
an electrolyte.

36. The battery of claim 35, wherein A is selected from the group consisting of Li, K, Na, and mixtures thereof.

37. The battery of claim 35, wherein A is Li.

38. The battery of claim 35, wherein M is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, and Pb²⁺.

39. The battery of claim 35, wherein M is selected from the group consisting of Ti³⁺, V³⁺, Cr³⁺, Mn³⁺, Fe³⁺, Co³⁺, Ni³⁺, Mo³⁺, and Nb¹⁺.

40. The battery of claim 35, wherein M=MIₙMIIₒ, 0<o+n≦4 and 0<o,n, wherein MI and MII are each independently selected from the group consisting of redox active elements and non-redox active elements, wherein at least one of MI and MII is redox active.

41. The battery of claim 40, wherein MI and MII are both redox active.

42. The battery of claim 40, wherein MI is substituted by MII by isocharge substitution.

43. The battery of claim 42, wherein M=MIₙ₋ₚMIIₒ, and o=p.

44. The battery of claim 42, wherein M=MIₙ₋ₚMIIₒ, and o≠p.

45. The battery of claim 42, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof.

46. The battery of claim 42, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, and mixtures thereof.

47. The battery of claim 42, wherein MI is selected from the group consisting of Ti²⁺, V²⁺, Cr²⁺, Mn²⁺, Fe²⁺, Co²⁺, Ni²⁺, Cu²⁺, Mo^{2+l , Si}²⁺, Sn²⁺, Pb²⁺, and mixtures thereof, and MII is selected from the group consisting of Zn²⁺, Cd²⁺, and mixtures thereof.

48. The battery of claim 42, wherein MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Sc³⁺, Y³⁺, B³⁺, Al³⁺, Ga³⁺, In³⁺, and mixtures thereof.

49. The battery of claim 42, wherein MI is substituted by MII by aliovalent substitution.

50. The battery of claim 49, wherein M=MIₙ₋ₒMIIₒ.

51. The battery of claim 49, wherein
$$M = M {I}_{n - \frac{o}{{V}^{MI}}} M I {I}_{\frac{o}{{V}^{MII}}} ,$$
wherein V^{MI} is the oxidation state of MI, and V^{MII} is the oxidation state of MII.

52. The battery of claim 51, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Sc³⁺, Y³⁺, B³⁺, Al³⁺, Ga³⁺, In³⁺, and mixtures thereof.

53. The battery of claim 51, wherein MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of alkali metals, Cu¹⁺, Ag¹⁺, and mixtures thereof.

54. The battery of claim 51, wherein MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Be²⁺, Mg²⁺, Ca²⁺, Sr2+, Ba²⁺, Zn²⁺, Cd²⁺, Ge²⁺, and mixtures thereof.

55. The battery of claim 51, wherein MI is selected from the group consisting of Ti³⁺, V³⁺, Cr³⁺, Mn³⁺, Fe³⁺, Co³⁺, Ni³⁺, Mo³⁺, Nb³⁺, and mixtures thereof MII is selected from the group consisting of alkali metals, Cu¹⁺, Ag¹⁺, and mixtures thereof.

56. The battery of claim 35, wherein M=M1_{q}M2ᵣM3ₛ, wherein:
(a) M1 is a redox active element with a 2+ oxidation state;
(b) M2 is selected from the group consisting of redox and non-redox active elements with a 1+ oxidation state;
(c) M3 is selected from the group consisting of redox and non-redox active elements with a 3+ oxidation state; and
(d) at least one of q, r and s is greater than 0, and at least one of M1, M2, and M3 is redox active.

57. The battery of claim 56, wherein q=q−(r+s).

58. The battery of claim 56, wherein
$$M = M {1}_{q - \frac{r}{{V}^{M 1}} - \frac{s}{{V}^{M 1}}} M {2}_{\frac{r}{{V}^{M 2}}} M {3}_{\frac{s}{{V}^{M 3}}} ,$$
wherein V^{M1} is the oxidation state of M1, V^{M2} is the oxidation state of M2, and V^{M3} is the oxidation state of M3.

59. The battery of claim 58, wherein M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of alkali metals, Cu¹⁺, Ag¹⁺, and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof.

60. The battery of claim 58, wherein M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Li¹⁺, K¹⁺, Na¹⁺, Ru¹⁺, Cs¹⁺, and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof.

61. The battery of claim 58, wherein M1 is selected from the group consisting of Be²⁺, Mg²⁺, Ca²⁺, Sr²⁺, Ba²⁺, Zn²⁺, Cd²⁺, Ge²⁺, and mixtures thereof; and M3 from the group consisting of alkali metals, Cu¹⁺, Ag¹⁺, and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof.

62. The battery of claim 58, wherein M1 is selected from the group consisting of Be²⁺, Mg²⁺, Ca²⁺, Sr²⁺, Ba²⁺, Zn²⁺, Cd²⁺, Ge²⁺, and mixtures thereof; M2 is selected from the group consisting of Li¹⁺, K¹⁺, Na¹⁺, Ru¹⁺, Cs¹⁺, and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof.

63. The battery of claim 58, wherein M¹ is selected from the group consisting of Ti²⁺, V²⁺, Cr²⁺, Mn²⁺, Fe²⁺, Co²⁺, Ni²⁺, Cu²⁺, Mo²⁺, Si²⁺, Sn², Pb²⁺, and mixtures thereof; M2 is selected from the group consisting of alkali metals, Cu¹⁺, Ag¹⁺ and mixtures thereof; and M3 is selected from the group consisting of Sc³⁺, Y³⁺, B³⁺, Al³⁺, Ga³⁺, In³⁺, and mixtures thereof.

64. The battery of claim 58, wherein M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Li¹⁺, K¹⁺, Na¹⁺, Ru¹⁺, Cs¹⁺, and mixtures thereof; and M3 is selected from the group consisting of Sc³⁺, Y³⁺, B³⁺, Al³⁺, Ga³⁺, In³⁺, and mixtures thereof.

65. The battery of claim 56, wherein 0<q, r, s.

66. The battery of claim 35, wherein c=1.

67. The battery of claim 35, wherein c=3.

68. The battery of claim 35, wherein Z is OH.

69. The battery of claim 35, wherein Z is F.

70. The battery of claim 35, wherein the first electrode further comprises an electrically conductive diluent, and a binder.

71. The battery of claim 70, wherein the electrically conductive diluent is carbon.

72. The battery of claim 71, wherein the electrically conductive diluent is carbon black.

73. The battery of claim 72, wherein the first electrode comprises from 5 to 30% by weight carbon black.

74. The battery of claim 70, wherein the binder is a copolymer of polyvinylidene difluoride (PVdF) and hexafluoropropylene (HFP).

75. The battery of claim 74, wherein the first electrode comprises from 3 to 20% by weight binder.

76. The battery of claim 35, wherein the insertion active material is selected from the group consisting of a metal oxide, metal chalcogenide, carbon, graphite, and mixtures thereof.

77. The battery of claim 76, wherein the insertion active material is graphite.

78. The battery of claim 76, wherein the first and second electrodes each further comprise an electrically conductive diluent, and a binder.

79. The battery of claim 78, wherein the electrically conductive diluent is carbon.

80. The battery of claim 79, wherein the electrically conductive diluent is carbon black.

81. The battery of claim 80, wherein the first and second electrode each comprise from 5 to 30% by weight carbon black.

82. The battery of claim 78, wherein the binder is a copolymer of polyvinylidene difluoride (PVdF) and hexafluoropropylene (HFP).

83. The battery of claim 78, wherein the first and second electrode each comprise from 3 to 20% by weight binder.

84. The battery of claim 35, wherein the electrolyte comprises a lithium salt and a solvent selected from the group consisting of dimethyl carbonate (DMC), diethylcarbonate (DEC), dipropylcarbonate (DPC), ethylmethylcarbonate (EMC), ethylene carbonate (EC), propylene carbonate (PC), butylene carbonate, lactones, esters, glymes, sulfoxides, sulfolanes, and mixtures thereof.

85. The battery of claim 84, wherein the electrolyte comprises a solvent selected from the group consisting of EC/DMC, EC/DEC, EC/DPC and EC/EMC.

86. The battery of claim 84, wherein the electrolyte comprises from 5% to 65% by weight lithium salt.

87. The battery of claim 86, wherein the electrolyte comprises from 8% to 35% by weight lithium salt.
